(19) United States
(12) Patent Application Publication
(10) Pub. No.: US 2005/0006932 A1
(43) Pub. Date: Jan. 13, 2005

(54) Triathlete bicycle saddle

(76) Inventor: John Francis Laidlaw, Dearborn, MI (US)

Correspondence Address: JOHN F. LAIDLAW, 22261 AUDETTE, DEARBORN, MI, 48124, US

(21) Appl. No.: 10/617,414

(22) Filed: Jul. 11, 2003

(51) Int. Cl. B62J 1/00

(52) U.S. Cl. 297/201

(57) ABSTRACT

The triathlete bicycle saddle promotes a more aerodynamic position by enabling a flatter back while improving comfort and risk of injury by eliminating direct compression on the perineal region (crotch). The saddle is specifically designed for athletes riding in a more aggressive, aerodynamic position by supporting the athlete's weight on the seat bones and not on the perineal region. The truncated horn provides sufficient lateral support during cornering and descents. A guide loop on the nose of the saddle promotes smooth transition to the seated position by automatically centering and aligning the seat. The double cantilever rail frame provides additional comfort by reducing road vibration and shock through an independent suspension of the saddle body.

### FIELD OF INVENTION

The invention relates to a bicycle saddle (seat) and more specifically a bicycle saddle for cyclists maintaining an aggressive, aerodynamic position, which eliminates direct pressure on the urogenital triangular region of the perineum while focusing support to the seat bones (Ischium) and providing a centering feature and lateral support.

### BACKGROUND OF THE INVENTION

In recent years, there has been mounting evidence to link traditional bicycle saddles with a list of medical conditions ranging from temporary genital/perineal numbness to impotence. The primary cause of these afflictions can be attributed to the compression of blood vessels and nerves passing through the perineal region; sandwiched between the pelvic bone and the horn of the bicycle saddle.

The horn extends from the rear of the saddle between the cyclist's legs. In competitive cycling, periodic exertions require the athlete to ‘jump’ out of the saddle, and then quickly return to a seated position to conserve energy. The horn of the saddle plays a crucial role in guiding and centering the athlete to the saddle. Furthermore, the horn provides lateral support of the athlete in turns, downhill descents and evasive maneuvers.

While prior inventions such as described in U.S. Pat. No. 6,068,333 and U.S. Pat. No. 6,471,291 similarly focus on reducing perineal contact/pressure, none of them provide a comprehensive solution for riders as disclosed by herein invention. Weight, minimal design, centering/orienting feature and comfort are all key design parameters and optimized by the herein disclosure.

### SUMMARY OF THE INVENTION

A bicycle saddle that reduces perineal pressure while providing a centering/orienting feature and lateral support of the rider includes:

A triple-bend hairpin rail frame supports the saddle shell and enables mounting to any standard bicycle seat post. The frame provides a cantilever suspension of the saddle shell to improve comfort by reducing road vibration and shock.

A saddle shell to provide form, structure and support of the rider. The shell deviates from a traditional saddle with a truncated horn and a U-shaped opening along the median to eliminate perineal contact. The absence of any material contacting the perineal region prevents hard compression of blood vessels and nerves. The truncated horn (nose) is sufficient to orient/center the rider onto the saddle. Furthermore, the nose provides sufficient lateral support in turns. The saddle shell is designed to support the rider's weight through the seat bones that contact the rear of the saddle shell.

A guide loop on the nose (nose loop) of the truncated horn provides smooth transitions of the rider to the seated position by aligning/centering the saddle between the rider's legs. The nose loop prevents snagging or catching of the rider's leg or clothing on the truncated horn. Additionally, the loop provides structural support and stiffness to the shell.

The invention allows the athlete to rotate the pelvis without compressing the perineum whereby maintaining a flatter back and better aerodynamics. Overall performance and comfort are improved with reduced road vibration, better aerodynamics, absence of perineal compression, and proper distribution of the rider's weight on the seat bone (Ischium).

### BRIEF DESCRIPTION OF THE DRAWINGS

FIG. 1 is a top-side perspective view of the triathlete bicycle saddle;

FIG. 2 is an exploded view of the triathlete bicycle saddle of FIG. 1 illustrating the mounting rail 102 and seat body shown generally as 100.

FIG. 3 depicts a top plan view of the triathlete bicycle saddle with outline of the support rail 102;

FIG. 4 is a sectional view taken along line 44 of FIG. 3. The saddle body 100 is comprised of a shell 101 with optional foam padding 105 and material cover (or skin) 104.

### DESCRIPTION OF THE PREFERRED EMBODIMENTS

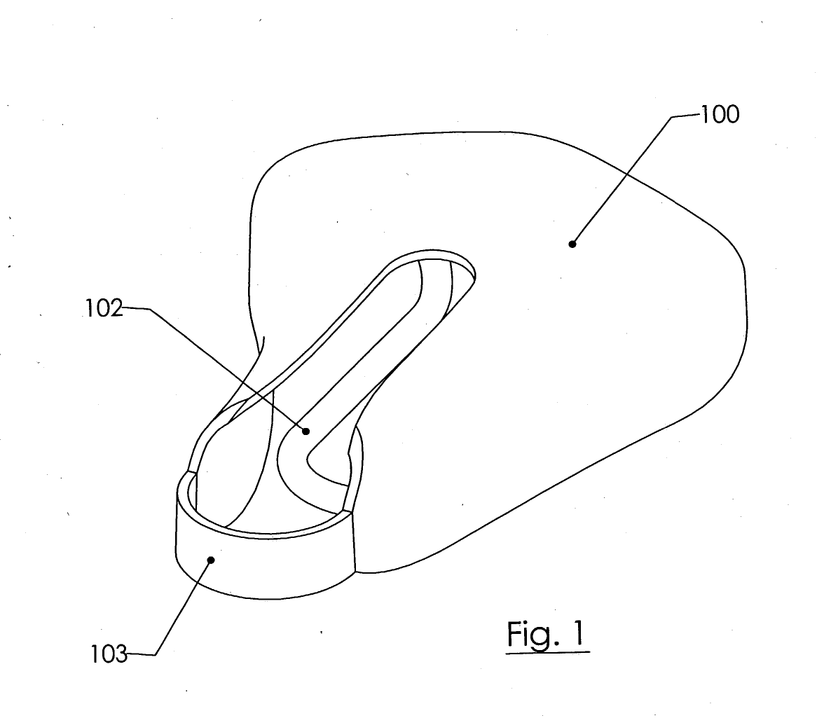

Referring to FIG. 1, a bicycle saddle of the present invention is shown. The bicycle saddle includes an anatomically shaped saddle 100, which deviates from traditional saddles by implementing a truncated horn and a U-shaped relieved region. These features eliminate direct compression of the urogenital triangular region of the perineum preventing damage to nerves and blood vessels. The truncated horn provides sufficient lateral support of the rider in turns, and aligns/centers and guides the rider to the seated position. A nose loop 103 at the forefront of the truncated horn prevents snagging of the rider's body or clothing for smooth transitions to the seated position. Additionally, the nose loop 103 improves structural strength and stiffness of the saddle.

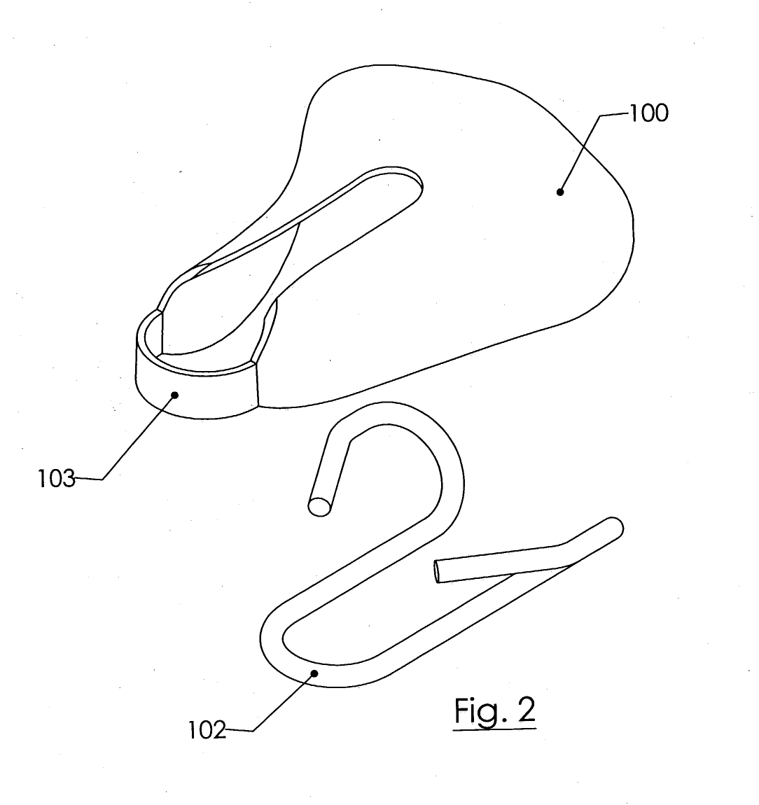

Referring to FIG. 2, the saddle body 100 is supported by a triple-bend, hairpin rail frame 102. Preferably, the rail frame is fabricated from a rod of spring steel. A U-shaped base has two parallel mounting rails to provide sufficient fore/aft adjustment of the saddle in any standard seat post for installation on any standard bicycle. The rails symmetrically transition to a shell support plane with a wider span between rails to provide stability of the saddle and directly support the seat bone (Ischium). The two cantilevered frame arms support the saddle body 100 and provide an independent, spring-like suspension to improve comfort by reducing road vibration and shock.

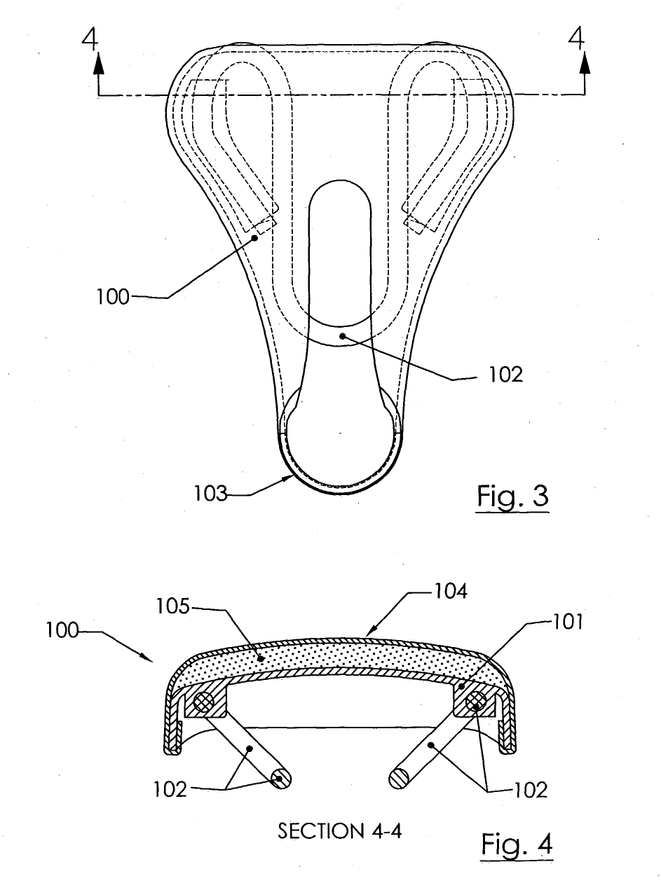

Referring to FIG. 3 and FIG. 4, the saddle body 100 is comprised of a shell 101; a nose loop 103, optional foam padding 105 and an optional material cover 104.

Preferably, the saddle shell 101 is a molded plastic with the nose loop 103 as an integrated feature. Additionally, the rail frame 102 would be insert-molded into the plastic shell 101.

The triathlete bicycle saddle improves the comfort and performance of elite cyclists by eliminating direct compression of the perineal region, which enables the pelvic region to rotate forward to foster a more aerodynamic position devoid of pain and injury.

1. A bicycle saddle shell consisting of a truncated horn region, which transitions from the rear of the saddle that supports the seat bones (Ischia), and terminates posterior to the genital region of the seated rider.

2. A saddle shell defined by a relieved region starting at the forefront and extending towards the rear of the saddle in a section that corresponds to the urogenital triangular region of the seated rider's perineum.

3. The device in claim 2 wherein the relieved region is completely devoid of material.

4. The device of claim 2 wherein the relieved region is a recessed channel.

5. A guide at the nose of the saddle that bridges the sides of the saddle shell to provide: a blended element for smooth transition of the rider to the seated position, and lateral rigidity to the anterior of the saddle shell while preserving a level of compliance in other vectors of motion.

6. The device in claim 5, wherein an arched band blends with the nose of the saddle shell.

7. A suspension device with two independently compliant extensions to: mount and support the saddle shell, provide a means of attachment to the seat post with sufficient fore/aft adjustment, and enable independent pitch and roll of the two halves of the saddle shell corresponding to the left and right seat bone (Ischium).

8. The device in claim 7 wherein a double-cantilever rail frame consisting of a triple-bend, hairpin to mount and support the saddle shell. A U-shaped base with two parallel mounting rails to provide sufficient fore/aft adjustment of the saddle in any standard seat post for installation on any standard bicycle. The rails symmetrically transition to a shell support plane with a wider span between rails to provide stability of the saddle and directly support the seat bone (Ischium).
